(19) United States
(12) Patent Application Publication
(10) Pub. No.: US 2022/0351351 A1
(43) Pub. Date: Nov. 3, 2022

(54) TURBINE BLADE CREEP MONITORING

(71) Applicant: ROLLS-ROYCE plc, London (GB)

(72) Inventors: Adriano PULISCIANO, Birmingham (GB); Bilal M. NASSER, Derby (GB)

(73) Assignee: ROLLS-ROYCE plc, London (GB)

(21) Appl. No.: 17/712,631

(22) Filed: Apr. 4, 2022

(30) Foreign Application Priority Data
Apr. 29, 2021 (GB) 2106108.0

(51) Int. Cl. G06T 7/00; G01M 15/14; G01M 5/00

(52) U.S. Cl. CPC G06T 7/001; G01M 15/14; G01M 5/0016; G01M 5/0041; F01D 5/005

(57) ABSTRACT

A method of monitoring turbine blade creep in a gas turbine engine is provided. The method includes: receiving an image of a turbine blade of a row of turbine blades, the image having been obtained using a borescope located in the engine adjacent a row of turbine blades; measuring on the image a distance between radially inner and radially outer landmarks on the turbine blade; and comparing the measured distance with a reference distance to determine an amount of creep-induced lengthening of the blade.

### CROSS-REFERENCE TO RELATED APPLICATIONS

This specification is based upon and claims the benefit of priority from UK Patent Application Number 2106108.0 filed on Apr. 29, 2021, the entire contents of which are incorporated herein by reference.

### TECHNICAL FIELD

The present disclosure relates to a method and a system for monitoring turbine blade creep in a gas turbine engine.

### BACKGROUND

Conventionally borescopes are used to view internal components within an assembled gas turbine engine to determine if the components within the engine are damaged and need repair or if they are undamaged and do not require repair. The use of borescopes enables the components to be viewed without having to disassemble the gas turbine engine into modules or sub modules.

The current approach for on-wing assessment of turbine blade creep is to use a borescope to visually estimate the radial growth of a blade with a borescope by observing the size of the gap between a shroud of the blade and a liner forming the outer wall of the working annulus of the engine.

This provides a qualitative measure of creep in the blade, but it is non-quantifiable, and results vary between operators. Metrical (i.e. quantitative) measurement is currently performed by stripping down the engine and precisely measuring the dimensions of the top of the blade using a coordinate measurement machine (CMM). This is time-consuming and expensive and can only be performed when the engine is in a maintenance facility with the necessary equipment. Turbine blades are currently used for a conservative number of operation cycles. More accurate determination of turbine blade creep allows for the turbine blades to be used for a longer duration, reducing operating costs.

Accordingly, current approaches to creep measurement lack consistency, are inefficient, and do not generally provide enough quantitative data to understand creep growth in different cycling stages and on different parts of the blade. As a result, turbine blades may be replaced unnecessarily early in their life cycle, adding substantially to engine running costs.

### BRIEF SUMMARY

According to a first aspect there is provided a method of monitoring turbine blade creep in a gas turbine engine, the method including:
receiving an image of a turbine blade of a row of turbine blades the image having been obtained using a borescope located in the engine adjacent a row of turbine blades;
measuring on the image a distance between radially inner and radially outer landmarks on the turbine blade; and
comparing the measured distance with a reference distance to determine an amount of creep-induced lengthening of the blade.

The present disclosure is at least partly based on a realisation that a measurement distance derived from a borescope image can be sufficiently repeatable and accurate to reliably monitor creep-induced lengthening of the blade. Moreover, the method can be performed on-wing and without stripping down the engine. Thus, it facilitates consistent and relatively frequent measurements from which creep growth in different cycling stages and on different parts of the blade can be understood.

Optional features of the method of the first aspect will now be set out. These are applicable singly or in any combination.

The landmarks may be respectively on a platform and a shroud of the turbine blade. A measured distance between such landmarks is highly sensitive to creep-induced lengthening of the blade. For example, each landmark may conveniently be a corner of the respective platform or shroud closest the trailing edge of the blade.

The measurement on the image of the distance between the radially inner and radially outer landmarks on the turbine blade may include: identifying on the image, or a corresponding image, a feature of the turbine blade having a known size; determining therefrom a distance conversion scale; and using the conversion scale to determine the distance between the radially inner and radially outer landmarks. For example, the feature can be a spacing of known distance between two air film cooling holes formed in the blade. As another example, the feature can be a superficial marking or discolouration blemish of known size.

The borescope may be a conventional borescope or a stereo borescope which is used to obtain left and right images, the measuring being performed for each of the left and right images. This can improve the accuracy of and increase the confidence in the determination of creep-induced lengthening.

Indeed, more generally, the measuring may be performed plural times for different images of the blade (e.g. left and right images and/or different stills of a video of the turbine blade as the row of turbine blades rotates). The measurements can then provide an average measured distance for comparison with the reference distance.

The reference distance may be the distance between the radially inner and radially outer landmarks for a turbine blade which has not experienced creep. For example, this reference distance may be determined by measuring an actual blade or by extracting the distance information from a 3D model (e.g. a CAD model or a scan data model) of the blade.

The measuring may include performing automated image analysis to extract edge lines of the turbine blade from the image. For example, the extracted lines can be the trailing edge line, one or more platform edge lines and/or one or more shroud edge lines from the image. This can facilitate the measurement of the distance between the radially inner and radially outer landmarks, and can help to remove a source of operator variation. The image analysis may perform image filtering as a precursor to extracting the edge lines of the blade.

The receiving, measuring and comparing may be performed for each of successive turbine blades of the row of turbine blades. In particular the method can be used to monitor all the turbine blades of the row for creep.

The method may further include: calibrating the borescope to determine imaging distortions produced thereby; and using the calibration to adjust the image to remove or reduce imaging distortions before the measurement on the image of the distance between radially inner and radially outer landmarks on the turbine blade.

The method may further include, preliminary to receiving the image of a turbine blade: locating the borescope in the engine adjacent the row of turbine blades; and using the borescope to obtain the image of the turbine blade of the row of turbine blades.

Locating the borescope in the engine may comprise inserting the borescope into a port on an accessible part of the engine. Guiding the borescope through a guide tunnel until the end of the borescope is at the end of the guide tunnel. The borescope and/or guide tube may be shaped or comprise fitments to improve the reproducibility of positioning the borescope.

The borescope may be used to obtain a video of the turbine blade as the row of turbine blades rotates, the image being a still extracted from the video.

According to a second aspect there is provided a system for monitoring turbine blade creep in a gas turbine engine, the system including:
a computer readable medium for storing an image of a turbine blade of a row of turbine blades, the image having been obtained using a borescope located in the engine adjacent the row of turbine blades; and
a processor-based sub-system operationally connected to the computer readable medium and adapted to:
   perform automated image analysis to measure a distance between radially inner and radially outer landmarks on the blade; and
   compare the measured distance with a reference distance to determine an amount of creep-induced lengthening of the blade.

Thus, the system of the second aspect corresponds to the method of the first aspect.

Optional features of the method of the first aspect pertain also to the system of the second aspect.

Thus, the landmarks may be respectively on a platform and a shroud of the turbine blade. For example, each landmark may be a corner of the respective platform or shroud closest the trailing edge of the blade.

The measurement on the image of the distance between radially inner and radially outer landmarks on the turbine blade performed by the automated image analysis may include:

identifying on the image, or a corresponding image, a feature of the turbine blade having a known size; determining therefrom a distance conversion scale; and using the conversion scale to determine the distance between the radially inner and radially outer landmarks.

The borescope may be a stereo borescope which is used to obtain left and right images, the measuring and comparing being performed for each of the left and right images.

The reference distance may be the distance between the radially inner and radially outer landmarks for a turbine blade which has not experienced creep.

The processor-based sub-system may be further adapted to extract edge lines of the turbine blade from the image, e.g. as a precursor to measuring the distance between the radially inner and radially outer landmarks. The processor-based sub-system may be further adapted to perform image filtering as a precursor to extracting the edge lines.

The processor-based sub-system may be further adapted to: calibrate the borescope to determine imaging distortions produced thereby; and use the calibration to adjust the image to remove or reduce imaging distortions before performing the automated image analysis.

The system may further include a borescope adapted to be located in the engine adjacent the row of turbine blades for obtaining the image of the turbine blade of the row of turbine blades, the computer readable medium being operatively connectable to the borescope to receive therefrom the image of the turbine blade.

The borescope may be adapted to obtain a video of the turbine blade as the row of turbine blades rotates, the image being a still extracted from the video.

The method of the first aspect is typically computer-implemented. Accordingly, further aspects of the disclosure provide: a computer program comprising code which, when the code is executed on a computer, causes the computer to perform the method of the first aspect; and a computer readable medium storing a computer program comprising code which, when the code is executed on a computer, causes the computer to perform the method of the first aspect.

### BRIEF DESCRIPTION

Embodiments will now be described by way of example only, with reference to the Figures, in which:

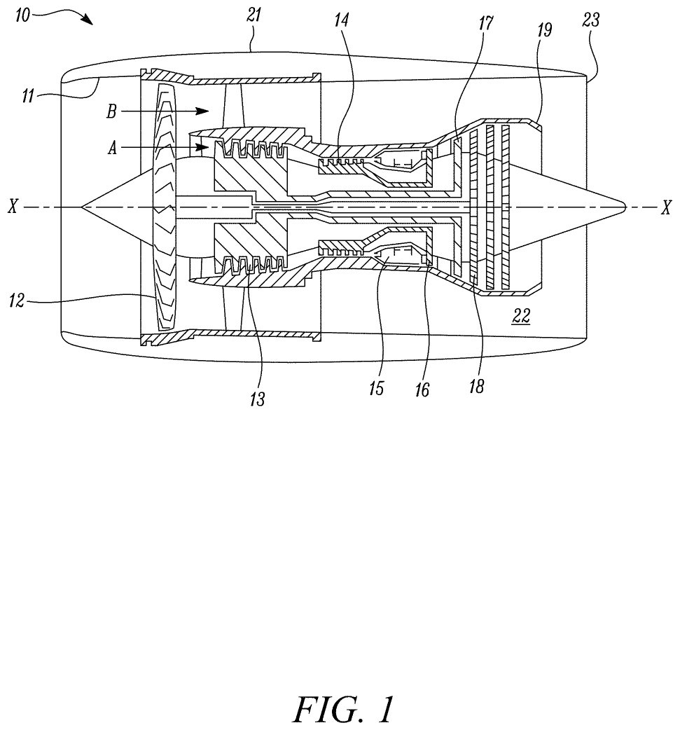

FIG. 1 shows a longitudinal cross-section through a ducted fan gas turbine engine;

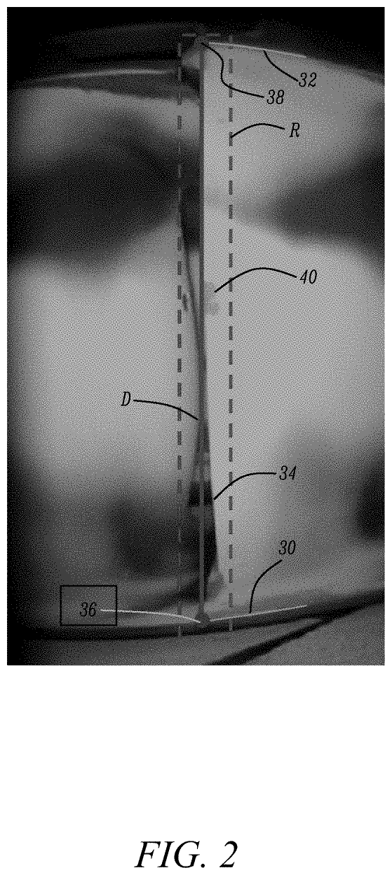

FIG. 2 shows an image of a turbine blade obtained by a borescope; and

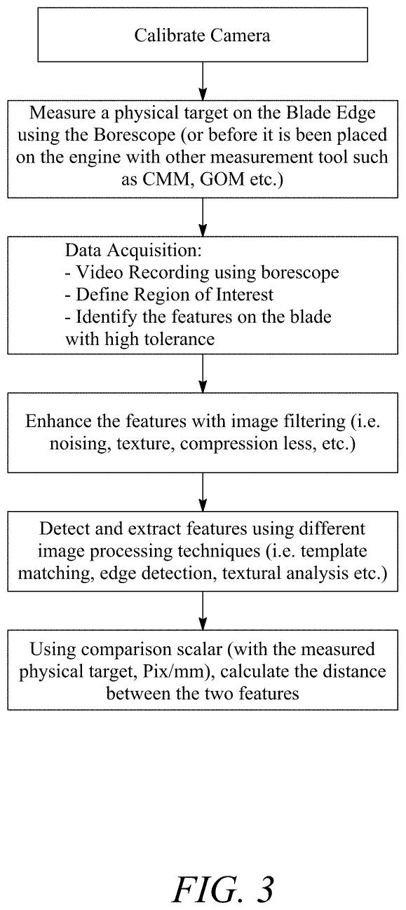

FIG. 3 shows a flow chart of stages in a procedure for monitoring a blade for creep-induced deformation.

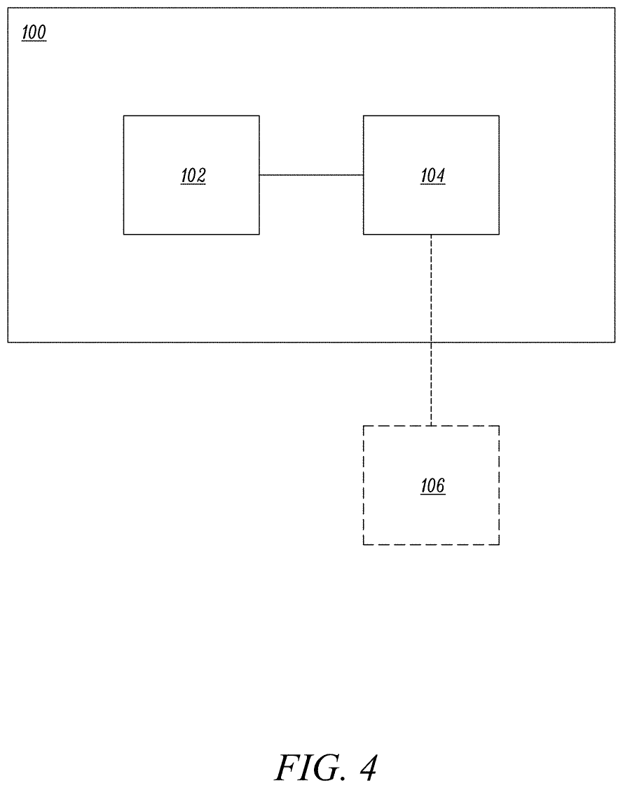

FIG. 4 shows a schematic representation of a system in accordance with an aspect of the invention.

### DETAILED DESCRIPTION

With reference to FIG. 1, a ducted fan gas turbine engine is generally indicated at 10 and has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate-pressure compressor 13 and a second air flow B which passes through the bypass duct 22 to provide propulsive thrust. The intermediate-pressure compressor 13 compresses the air flow A directed into it before delivering that air to the high-pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate-pressure compressors 14, 13 and the fan 12 by suitable interconnecting shafts.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The turbine blades of the turbines 16, 17, 18, which are exposed to high centrifugal forces and high temperatures from the working gas expanding through the turbines, are vulnerable to creep deformation. Accordingly, regular inspection of the blades is performed using a borescope to monitor for creep-induced deformation.

Preliminary to the inspection, the borescope can be calibrated to determine any imaging distortions which it produces. Various calibration procedures are known to the skilled person, such as described for example by Zhengyou Zhang, A Flexible New Technique for Camera Calibration, Technical Report MSR-TR-98-71, https://www.microsoft.com/en-us/research/wp-content/uploads/2016/02/tr98-71.pdf. The calibration can then be used to adjust images obtained by the borescope to remove or reduce imaging distortions.

The borescope is located adjacent a row of blades to obtain an image of part of the row. The row is then rotated so that each blade in turn is moved into position to be imaged by the borescope. This can be achieved by indexing the rotational position of the row, or more conveniently by using the borescope to obtain a video of the row as it continuously rotates.

Respective stills can then be extracted from the video for the blades, each still corresponding to its blade being in a given position relative to the borescope.

FIG. 2 shows one such still for a blade. Borescopes conventionally have distance measuring capability. This can be used directly to measure distances on the image. However, particularly for larger scale measurements beyond the normal measuring range of borescopes, better accuracies can be obtained by determining a distance conversion scale, for example in pixels/mm, based on features of known size. For example, the spacings between air film cooling holes formed in the blade are generally known to high accuracy and can be used to determine such a scale. Another option is to measure the length of a superficial marking or discolouration blemish of known size (as determined e.g. by a coordinate measuring machine), such as marking 40 at the trailing edge 34 of the blade shown in FIG. 2, and using that to determine the scale.

The scale determined for the image of one blade, can be applied without loss of significant accuracy to corresponding images of other blades.

Having extracted the relevant stills and saved them into suitable memory, a processor-based image analyser performs edge detection on each image. For example, the image analyser may perform image filtering (e.g. noising filtering, texture filtering, compression-less filtering etc.) to enhance the images. The image analyser may, for example, perform canny edge detection to identify edge in the image, the image analyser may then perform a Hough transformation to reject unwanted lines. Typically, edges corresponding to the trailing edge of the blade 34, an edge 30 of the platform of the blade, and an edge 32 of the shroud of the blade are then detected by the image analyser (e.g. using template matching, edge detection, textural analysis etc.) and the lines of these edges extracted.

The image analyser may ensure that the trailing edge 34 is in a defined region of interest (rectangle R in FIG. 2), whereby the image analyser can confirm that the blade is appropriately positioned relative to the borescope prior to distance measurement. This may further improve accuracy of edge detection by further improving reproducibility of lighting of the turbine blade.

The image analyser then identifies two landmarks. These are indicated on FIG. 2 as a radially inner landmark 36 which is the corner of the platform edge 30 closest to the trailing edge 34, and a radially outer landmark 38 which is the corner of the shroud edge 32 closest to the trailing edge 34. The distance D between these two landmarks is determined either by applying a conversion scale to convert from pixels to actual distance. The conversion scale may be determined by direct measurement by the borescope, or indirectly by measuring a known distance between two features on the borescope images e.g. between two cooling holes. Accurate measurement between two visible features (e.g. cooling holes, surface defects) may be made by the borescope at a position close to the turbine blade. The conversion may be applied to the distance D between the two landmarks which is taken at a larger field of view.

The image analyser compares the measured distance D with a reference distance to determine an amount of creep-induced lengthening of the blade. The reference distance is typically the corresponding distance for a turbine blade which has not experienced creep. This can be obtained by measuring an actual blade, or by extracting the distance information from a 3D model of the blade.

FIG. 3 summarises stages of the creep monitoring procedure.

Advantageously, because the measurement of distance can be over the whole radial length of the blade, the accuracy of the measurement is improved. That is, any measurement of change in length due to creep is increased relative to approaches which do not use the whole length.

If the borescope is a stereo borescope, simultaneous left and right images can be obtained of each blade to double the number of distance measurements from each still. Table 1 below shows example distance measurement results for left and right images of a blade obtained using a stereo borescope for six successive stills with the blade changing position slightly (due to rotation) between each still.

TABLE 1

| | Left | Right |
|---|---|---|
| Still 1 | 61.0 mm | 61.1 mm |
| Still 2 | 61.2 mm | 60.7 mm |
| Still 3 | 60.9 mm | 60.9 mm |
| Still 4 | 61.1 mm | 61.2 mm |
| Still 5 | 60.9 mm | 61.0 mm |
| Still 6 | 60.9 mm | — |

An average of the measurements may be determined for comparison with the reference distance. In addition, using left and right stereo images provides a useful check on edge detection and landmark identification. In still 6, for example, no distance measurement was made for the right image because the image analyser was unable to extract and identify one or both of the landmarks.

FIG. 4 shows a system 100 according to an aspect. The system 100 comprises a computer readable storage medium 104 for storing I.A. stereo images received from a borescope 106. The system 100 also comprises a processor-based sub-system 102. The processor-based sub-system 102 is operationally connected to the computer readable storage medium. The operational connection between the processor-based sub-system 102 and the computer readable storage medium 104 may enable the processor-based sub-system to access images or video stored on the computer readable storage medium 104 and optionally a 3D reference model stored on the computer readable storage medium. The processor-based sub-system 102 may be adapted to perform the methods disclosed herein.

The processor-based sub-system 102 may be adapted to receive an image of a turbine blade of a row of turbine blades, the image having been obtained using a borescope located in the engine adjacent a row of turbine blades. The processor-based sub-system 102 may measure on the image a distance (D) between radially inner and radially outer landmarks (36, 38) on the turbine blade; and may compare the measured distance with a reference distance to determine an amount of creep-induced lengthening of the blade.

In embodiments, the system may comprise a borescope 106 shown in FIG. 4 in a dashed line. The computer readable medium may be operatively connected to the borescope to receive the images and/or video of the turbine blade from the borescope 106. In some embodiments control of the borescope 106 may be performed by the processor-based sub-system 102. The borescope 106 may be adapted to be located in the engine adjacent the row of turbine blades for obtaining the images and/or video of the turbine blade of the row of turbine blades. In embodiments, the video of the turbine blade may be captured as a row of turbine blades rotates. The processor-based sub-system 102 may be adapted to extract and analyse still images from the video stored on the computer readable storage medium 104.

The processor-based sub-system 102 may be adapted to extract edge lines (30, 32, 34) of the turbine blade from the image as a precursor to measuring the distance between the radially inner and radially outer landmarks.

The processor-based sub-system 102 may be adapted to identify landmarks on the turbine blade wherein the landmarks are respectively on a platform and a shroud of the turbine blade.

The processor-based sub-system 102 may be adapted to identify on an image, or a corresponding image, a feature (40) of the turbine blade having a known size; and to determine therefrom a distance conversion scale; and using the conversion scale to determine the distance between the radially inner and radially outer landmarks.

The processor-based sub-system 102 may be adapted to calibrate the borescope to determine imaging distortions produced thereby; and to use the calibration to adjust an image to remove or reduce imaging distortions before the measurement on the image of the distance between radially inner and radially outer landmarks on the turbine blade.

Embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

The term “computer readable medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “computer-readable medium” includes but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer readable medium. One or more processors may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

All references cited herein are incorporated by reference.

We claim:

1. A method of monitoring turbine blade creep in a gas turbine engine, the method including:
receiving an image of a turbine blade of a row of turbine blades, the image having been obtained using a borescope located in the engine adjacent a row of turbine blades;
measuring on the image a distance between radially inner and radially outer landmarks on the turbine blade; and
comparing the measured distance with a reference distance to determine an amount of creep-induced lengthening of the blade.

2. The method according to claim 1, wherein the landmarks are respectively on a platform and a shroud of the turbine blade.

3. The method according to claim 2, wherein each landmark is a corner of the respective platform or shroud closest the trailing edge of the blade.

4. The method according to claim 1, wherein the measurement on the image of the distance between radially inner and radially outer landmarks on the turbine blade includes:
identifying on the image, or a corresponding image, a feature of the turbine blade having a known size;
determining therefrom a distance conversion scale; and
using the conversion scale to determine the distance between the radially inner and radially outer landmarks.

5. The method according to claim 1, wherein the reference distance is the nominal distance between the radially inner and radially outer landmarks for a turbine blade which has not experienced creep.

6. The method according to claim 1, wherein the measuring includes performing automated image analysis to extract edge lines of the turbine blade from the image.

7. The method according to claim 1, wherein the receiving, measuring and comparing are performed for each of successive turbine blades of the row of turbine blades.

8. The method according to claim 1, further including:
calibrating the borescope to determine imaging distortions produced thereby; and
using the calibration to adjust the image to remove or reduce imaging distortions before the measurement on the image of the distance between radially inner and radially outer landmarks on the turbine blade.

9. The method according to claim 1, further including, preliminary to receiving the image of a turbine blade:
locating the borescope in the engine adjacent the row of turbine blades; and
using the borescope to obtain the image of the turbine blade of the row of turbine blades.

10. The method according to claim 1, wherein the borescope is used to obtain a video of the turbine blade as the row of turbine blades rotates, the image being a still extracted from the video.

11. A system for monitoring turbine blade creep in a gas turbine engine, the system including:
a computer readable medium for storing an image of a turbine blade of a row of turbine blades, the image having been obtained using a borescope located in the engine adjacent the row of turbine blades; and
a processor-based sub-system operationally connected to the computer readable medium and adapted to:
perform automated image analysis to measure a distance between radially inner and radially outer landmarks on the blade; and
compare the measured distance with a reference distance to determine an amount of creep-induced lengthening of the blade.

12. The system according to claim 11, wherein the measurement on the image of the distance between radially inner and radially outer landmarks on the turbine blade performed by the automated image analysis includes:
identifying on the image, or a corresponding image, a feature of the turbine blade having a known size;
determining therefrom a distance conversion scale; and
using the conversion scale to determine the distance between the radially inner and radially outer landmarks.

13. The system according to claim 11, wherein the processor-based sub-system is further adapted to extract edge lines of the turbine blade from the image as a precursor to measuring the distance between the radially inner and radially outer landmarks.

14. The system according to claim 11, further including a borescope adapted to be located in the engine adjacent the row of turbine blades for obtaining the image of the turbine blade of the row of turbine blades, the computer readable medium being operatively connectable to the borescope to receive therefrom the image of the turbine blade.

15. The system according to claim 11, wherein the borescope is adapted to obtain a video of the turbine blade as the row of turbine blades rotates, the image being a still extracted from the video.
